(19) United States
(12) Patent Application Publication
(10) Pub. No.: US 2015/0296166 A1
(43) Pub. Date: Oct. 15, 2015

(54) SETTING METHOD OF DISPLAY MODE AND DISPLAY MODE CONFIGURING SYSTEM

(71) Applicants: BOE TECHNOLOGY GROUP CO., LTD., Beijing (CN); Beijing BOE Vision-Electronic Technology Co., Ltd., Beijing (CN)

(72) Inventor: Bin LIN, Beijing (CN)

(73) Assignees: BOE TECHNOLOGY GROUP CO., LTD., Beijing (CN); Beijing BOE Vision-Electronic Technology Co., Ltd., Beijing (CN)

(21) Appl. No.: 14/438,636

(22) PCT Filed: Sep. 29, 2013
(86) PCT No.: PCT/CN2013/084582

§ 371 Date: Apr. 27, 2015

(30) Foreign Application Priority Data
Jun. 6, 2013 (CN) 201310223831.0

(51) Int. Cl. H04N 5/44; H04N 21/41; H04N 21/418; H04N 21/485

(52) U.S. Cl. CPC H04N 5/4403; H04N 21/485; H04N 21/4126; H04N 21/4184

(57) ABSTRACT

The present invention provides a setting method of a display mode and a display mode configuring system, the setting method comprises the following steps: setting display mode parameters of a first display device; extracting and storing the display mode parameters of the first display device; setting a second display device based on the extracted display mode parameters of the first display device; and making the second display device display based on the display mode parameters of the first display device. In the present invention, through extracting the display mode parameters of the first display device, the display mode of the second display device is set, and compared to the manual setting, the operation is convenient and mistake is not easy to occur, thus on the premise of ensuring setting accuracy, the setting efficiency is increased.

### FIELD OF THE INVENTION

The present invention relates to the field of display technology, and particularly to a setting method of display mode and a display mode configuring system.

### BACKGROUND OF THE INVENTION

With the vigorous popularity of display devices, user's personalized requirements on the display devices are increasing more and more.

In order to meet the requirements, currently, many display devices have been provided with hardware interface for personalized settings for special conditions and special customer groups. With such hardware interface, a user may make some specified limitations to a display device according to requirements on application or his/her preferences, the specified limitations include various items, such as whether displaying a designated user logo (power on display picture), whether automatically switching the type of display input when powering on, whether automatically powering on when the display device is energized, power on volume, maximum allowable volume, input standard limitation, channel researching data and the like. Customers perform various mode settings on a display device through a hardware interface of the display device, and a different limitation item setting can be realized. When a mode setting to a certain display device is completed, the display device operates according to the set mode, such as a hotel mode, a cruise ship mode, a hospital mode, a prison mode and a shopping mall mode, so that each of customers may obtain a display device of a special mode corresponding to his/her requirements in his/her application place.

Generally, the special mode of the display device is manually set, that is, the display device, the mode of which is to be set, may be manually set to a mode setting state, and corresponding mode parameters may be manually set for each mode, then the set mode is saved and the mode setting state is quit. This manner may be easily realized for a single or a small number of display devices, however, in some public places (for example, a hospital), there are many display devices, and every display device has a plurality mode parameters to be set, in this case, shortcomings of manual setting is remarkable, thus operation is inconvenient, mistakes easily occur and the efficiency is low.

### SUMMARY OF THE INVENTION

In view of the above problems in the prior art, the present invention provides a setting method of a display device and a display mode configuring system. The setting method uses a mobile storage device as a configuration medium to set display mode of the display device, which can not only be carried easily, operated conveniently, uneasy to cause mistakes, but also increase the setting efficiency.

According to a first aspect of the present invention, there is provided a setting method of a display device, which comprises steps of:

setting display mode parameters of a first display device;

extracting and storing the display mode parameters of the first display device;

setting a second display device based on the extracted display mode parameters of the first display device; and

making the second display device display based on the display mode parameters of the first display device.

Preferably, the first display device includes a mode parameter storing module, and the step of setting display mode parameters of a first display device comprises:

manually setting the display mode parameters of the first display device respectively to form a mode parameter configuration file, and storing the mode parameter configuration file in the mode parameter storing module of the first display device.

Preferably, the display mode parameters of the first display device include:

a brightness parameter, a contrast parameter, a sound parameter, a saturation parameter and a user logo parameter.

Preferably, the first display device includes a mobile storage device hardware interface, and the step of extracting and storing the display mode parameters of the first display device comprises:

connecting the mobile storage device to the mobile storage device hardware interface of the first display device;

storing the mode parameter configuration file in the first display device into the mobile storage device; and

removing the mobile storage device from the mobile storage device hardware interface of the first display device.

Preferably, the second display device includes a mobile storage device hardware interface and a mode parameter storing module, and the step of setting the second display device based on the extracted display mode parameters of the first display device comprises:

connecting the mobile storage device to the mobile storage device hardware interface of the second display device;

copying the mode parameter configuration file in the mobile storage device to the mode parameter storing module of the second display device; and

removing the mobile storage device from the mobile storage device hardware interface of the second display device.

Preferably, the second display device includes a mode parameter reading module and a mode parameter running module, and the step of making the second display device display based on the display mode parameters of the first display device comprises:

the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

According to a second aspect of the present invention, there is provided a display mode configuring system comprising:

a first display device for generating a mode parameter configuration file based on a plurality of display mode parameters of the first display device;

a mobile storage device for storing the mode parameter configuration file therein when it is connected to the first display device; and

a second display device for reading the mode parameter configuration file from the mobile storage device and running it when the mobile storage device is connected thereto, so that the second display device displays based on the display mode parameters of the first display device.

Preferably, the first display device includes a first mode parameter storing module and a first mobile storage device hardware interface, the second display device includes a second mode parameter storing module and a second mobile storage device hardware interface, wherein the first mode parameter storing module stores the generated mode parameter configuration file, and the second mode parameter storing module stores the mode parameter configuration file read from the mobile storage device, and wherein the first mobile storage device hardware interface and the second mobile storage device hardware interface are used to connect with the mobile storage device.

Preferably, the first display device further includes a first mode parameter reading module and a first mode parameter running module, and the second display device further includes a second mode parameter reading module and a second mode parameter running module, wherein the first mode parameter reading module reads the mode parameter configuration file from the first mode parameter storing module to the first mode parameter running module, and the first mode parameter running module runs the mode parameter configuration file so that the first display device displays based on the display mode parameters, and the second mode parameter reading module reads the mode parameter configuration file from the second mode parameter storing module to the second mode parameter running module, and the second mode parameter running module runs the mode parameter configuration file so that the second display device displays based on the display mode parameters of the first display device.

In the present invention, when a display mode is set for a display device, through extracting the display mode parameters of the first display device, the display mode of the second device is set, compared to the manual setting, the operation is convenient and mistake is not easy to occur, thus on the premise of ensuring setting accuracy, the setting efficiency is increased.

### BRIEF DESCRIPTION OF THE DRAWINGS

Exemplary embodiments will be described in detail below on the basis of accompanying drawings, in which:

FIG. 1 illustrating a structural diagram of a display mode configuring system in an embodiment 1 of the present invention;

FIG. 2 illustrating a setting flow diagram of a display mode of a display mode setting system 100 in FIG. 1.

FIG. 3 illustrating a functional item menu diagram of a hotel mode of a display device in an embodiment 3 of the present invention;

FIG. 4 illustrating a setting flow diagram of a hotel mode of a second display device 102 in an embodiment 3 of the present invention; and

FIG. 5 illustrating a setting flow diagram of a user logo of a second display device 102 in an embodiment 4 of the present invention.

### DETAILED DESCRIPTION OF THE EMBODIMENTS

In order that those skilled in the art can better understand the technical solutions of the present invention, a further detailed description of a setting method of a display device and a display mode configuring system of the present invention will be given below in combination with the accompanying drawings and implementations.

### Embodiment 1

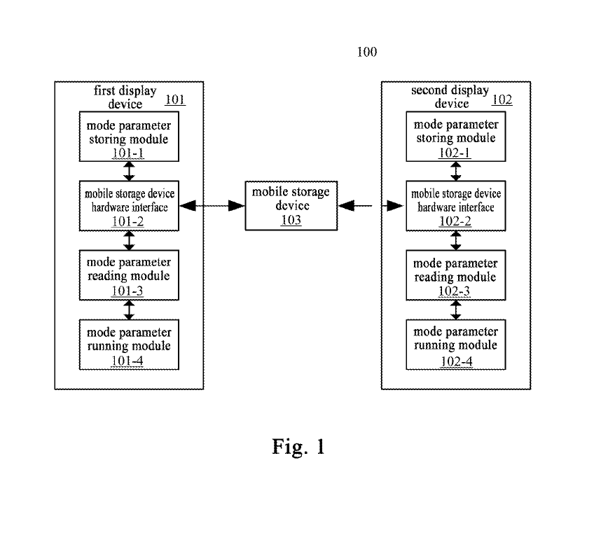

FIG. 1 illustrates a structural diagram of a display mode configuring system in an embodiment 1 of the present invention. The present embodiment provides a display mode configuring system 100, which includes a first display device 101, a second display device 102 and a mobile storage device 103, the first display device 101 includes a mode parameter storing module 101-1 and a mobile storage device hardware interface 101-2, and the second display device 102 includes a mode parameter storing module 102-1 and a mobile storage device hardware interface 102-2, the mode parameter storing modules 101-1 and 102-1 are used to store mode parameter configuration files, and the mobile storage device hardware interfaces 101-2 and 102-2 are used to connect to the mobile storage device 103. The mode parameter storing modules 101-1 and 102-1 are hardware mediums with storage function, for example, EEPROM (Electrically Erasable Programmable Read-Only Memory). The mobile storage device hardware interfaces 101-2 and 102-2 are interfaces adapted to the mobile storage device 103, and the mobile storage device hardware interfaces 101-2 and 102-2 have a function of driving the mobile storage device 103.

The first display device 101 includes a mode parameter reading module 101-3 and a mode parameter running module 101-4, and the second display device 102 includes a mode parameter reading module 102-3 and a mode parameter running module 102-4, the mode parameter reading modules 101-3 and 102-3 are used to read the mode parameter configuration files from the mode parameter storing modules 101-1 and 102-1 to the mode parameter running modules 101-4 and 102-4 respectively, the mode parameter running modules 101-4 and 102-4 are used to run the mode parameter configuration files, so that the first display device 101 and the second display device 102 display based on the display mode parameters of the first display device 101.

Hereinafter, setting methods of the display mode in embodiments 2-4 will be described based on the display mode configuring system 100 in the embodiment 1.

### Embodiment 2

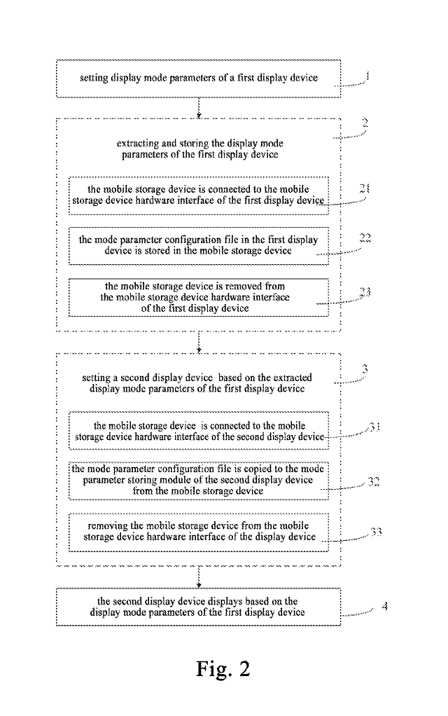

FIG. 2 illustrates a setting flow diagram of a display mode of the display mode setting system 100 in FIG. 1. As shown in FIG. 2, a setting method of the display mode in the present embodiment comprises following steps:

step 1, setting display mode parameters of a first display device 101.

Specifically, a plurality of display mode parameters of the first display device 101 are manually set respectively to form a mode parameter configuration file, and the mode parameter configuration file is stored in the mode parameter storing module 101-1 of the first display device 101. The plurality of display mode parameters of the first display device 101 specifically include a brightness parameter, a contrast parameter, a sound parameter, a saturation parameter and a user logo parameter. Before the display mode parameters of the first display device 101 are set, it is required to input an authorization password for the display mode of the first display device 101 first, then the display mode of the first display device 101 may be entered and set.

Step 2, extracting and storing the display mode parameters of the first display device 101.

This step specifically comprises:

step 21, the mobile storage device 103 is connected to the mobile storage device hardware interface 101-2 of the first display device 101; and

a mode parameter setting state of the display mode of the first display device 101 is entered by inputting the authorization password for the display mode of the first display device 101; and

step 22, the mode parameter configuration file in the first display device 10 is stored in the mobile storage device 103.

Specifically, in the first display device 101, a mode parameter configuration file is generated based on the display mode parameters thereof and copied to the mobile storage device 103, wherein content of the mode parameter configuration file includes: the set display mode parameters of the first display device 101, such as a code identifier or a code parameter. The code identifier or the code parameter is specific contents of display mode parameters in the display device, and these specific contents are represented by the code identifier or the code parameter.

step 23, the mobile storage device 103 is removed from the mobile storage device hardware interface 101-2 of the first display device 101.

In the present embodiment, the display mode parameters are extracted from the first display device 101 through the mobile storage device 103, and of course, the display mode parameters of the first display device 101 may be extracted by connecting the second display device 102 to the first display device 101 through a computer communication cable. The mobile storage device 103 includes a USB Flash Disk, a memory stick or other storage devices adapted to the mobile storage device hardware interface. Before the mode parameter configuration file is stored in the mobile storage device 103, it is necessary to format the mobile storage device 103, and available storage capacity of the formatted mobile storage device 103 is at least 100K bytes. The above step of storing the configuration file generated using the set display mode parameters of the first display device 101 in the mobile storage device 103 may be performed before the second display device 102 is set, or has been finished for a long time period before the second display device 102 is set, that is, as long as the storage of the display mode parameters in the mobile storage device 103 has been completed before the second display device 102 is set, which is not limited herein.

Step 3, setting a second display device 102 based on the extracted display mode parameters of the first display device 101.

The step specifically includes:

step 31, the mobile storage device 103 is connected to the mobile storage device hardware interface 102-2 of the second display device 102;

the mode parameter setting state of the display mode of the second display device 102 is entered by inputting the authorization password for the display mode of the second display device 102;

step 32, the mode parameter configuration file is copied to the mode parameter storing module 102-1 of the second display device 102 from the mobile storage device 103.

In order to ensure the accuracy of the display mode parameters, the step further comprises: the mode parameter configuration file is identified and verified.

Accordingly, the file content of the mode parameter configuration file further includes:

a file identification code, for identifying the beginning and end of the mode parameter configuration file, wherein the identification code includes a file beginning identification code and a file end identification code; and

a verification code, for verifying whether the code identification or code parameter in the mode parameter configuration file matches the code identification or code parameter of the mode parameter configuration in the second display device 102 or not.

Preferably, the format specification of the mode parameter configuration file is the same as those of the first display device 101 and the second display device 102, and the format specification of the mode parameter configuration file is FAT32, alternatively, the format specification of the mode parameter configuration file may also be NTFS.

Step 33, removing the mobile storage device 103 from the mobile storage device hardware interface 102-2 of the second display device 102.

Step 4, the second display device 102 displays based on the display mode parameters of the first display device 101.

The step specifically comprises: the mode parameter reading module 102-3 of the second display device 102 reads the mode parameter configuration file from the mode parameter storing module 102-1, the mode parameter running module 102-4 runs the mode parameter configuration file, so that the second display device 102 displays based on the display mode parameters of the first display device 101.

In the present embodiment, the display mode may be a hotel mode, a cruise ship mode, a hospital mode, a prison mode, a shopping mall mode or the like, and settings of the display mode parameters include settings of a brightness parameter, a contrast parameter, a sound parameter, a saturation parameter, a user logo parameter and parameters selected by user.

### Embodiment 3

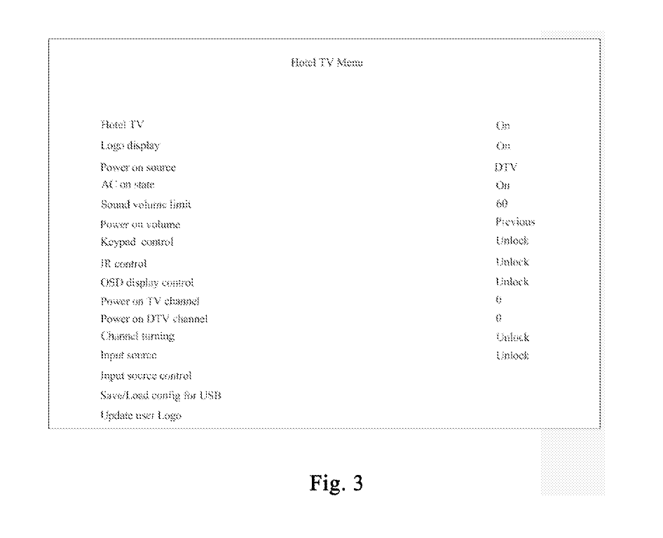

In the present embodiment, in order to explain the setting method of a display mode, setting of a hotel mode is taken an example, wherein the display mode is a hotel mode in which a plurality of display mode parameters shown in FIG. 3 are set.

When a display device to be set to the hotel mode is set with the same settings as that of a display device having been set to a hotel mode by using the setting method, specific setting procedures are as follows.

First, the parameters of the hotel mode of the first display device 101 are set, the hotel mode of the first display device 101 is set to be a specific mode as desired, and the set specific mode is stored in the mobile storage device 103.

The mobile storage device 103 is formatted into the same system format as the first display device 101 having been set to the hotel mode and the second display device 102 to be set to the hotel mode, for example, FAT32 or NTFS, and storage capacity of the formatted mobile storage device 103 is at least 100 k bytes.

The hotel mode parameter setting state of the first display device 101 (i.e., any display device having been set to the hotel mode) is entered by inputting the authorization password for the hotel mode of the first display device 101, for example, with respect to the first display device 101 of a certain model, the authorization password for the hotel mode may be inputted by a remote controller of the display device, for example, through inputting Menu→3→6→9→0, or the hotel mode parameter setting state of the first display device 101 is entered by manually inputting the authorization password for the display mode directly through a setting menu in the first display device 101. Then, the hotel mode parameters, such as the code identification and code parameters thereof, in the hotel mode of the first display device 101 may be manually set one by one, after the setting is completed, a mode parameter configuration file is automatically generated using these code identification and code parameters thereof and written in the mode parameter storing module 101-1 of the first display device 101, and a file name thereof is HotelSetting.cfg.

The formatted mobile storage device 103 is connected to the mobile storage device hardware interface 101-2 of the first display device 101 adapted to the mobile storage device 103 (for example, in a USB manner), a “storage/loading configuration” function item is selected in the hotel mode of the first display device 101, then the mode parameter configuration file in the mode parameter storing module 101-1 of the first display device 101 is written into the root directory of the mobile storage device 103, its file name is still HotelSetting.cfg.

Contents of the mode parameter configuration file include: the set parameters of the hotel mode, and identification code and verification code thereof, the contents and format of the mode parameter configuration file are shown in table 1:

TABLE 1
contents and format of the mode parameter configuration file

| | Content | | | |
|---|---|---|---|---|
| Code name | parameter | length | | description |
| ID1 | A5B6C7D8E9 | 10 | bytes | For beginning of |
| | | | | identification |
| Data | | variable | | Contents of the hotel |
| | | | | mode are stored in this area |
| Checksum | | 4 | bytes | All values of Data are |
| | | | | stored here after |
| | | | | being encrypted, for |
| | | | | confirming whether |
| | | | | errors occurs in |
| | | | | settable mode |
| | | | | contents |
| ID2 | 9E8D7C6B5A | 10 | bytes | For ending of |
| | | | | identification |

The parameter setting state of the hotel mode of the first display device 101 is quit, and the mobile storage device 103 is removed from the mobile storage device hardware interface 101-2 of the first display device 101.

Next, the hotel mode of the second display device 102 may be set to the same as that of the hotel mode stored in the mobile storage device 103 according to the hotel mode in the mode parameter configuration file stored in the mobile storage device 103.

The mobile storage device 103 is connected to the hardware interface 102-2 of the second display device 102 (that is, any one of display devices to be set to the hotel mode) adapted to the mobile storage device 103.

The mode parameter setting state of the hotel mode of the second display device 102 is entered by inputting the authorization password for the hotel mode of the second display device 102, again, the authorization password for the hotel mode may be inputted by a remote controller of the second display device 102, for example, through inputting Menu→3→6→9→0, or by manually inputting the authorization password for the hotel mode directly through a setting menu in the second display device 102.

A “storage/loading configuration” function item is selected in the hotel mode of the second display device 102, the mode parameter reading module of the second display device 102 begins to automatically research the root directory of the mobile storage device 103 for the mode parameter configuration file named HotelSetting.cfg, if the mode parameter configuration file is not found, then the mode parameter configuration file not existing is prompted, and if the mode parameter configuration file is found, contents of the mode parameter configuration file named HotelSetting.cfg is read and written into the inner mode parameter storing module 102-1.

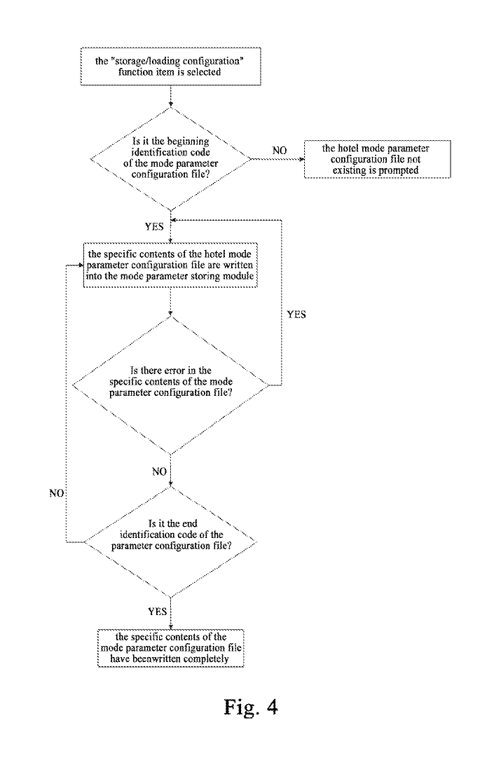

As shown in FIG. 4, the “storage/loading configuration” function item is selected, when the mode parameter configuration file is found in the root directory of the mobile storage device 103, the mode parameter storing module 102-1 of the second display device 102 may first identify and verify the mode parameter configuration file. Identification of the mode parameter configuration file includes: an identification of the beginning of the mode parameter configuration file (the beginning identification code of the parameter configuration file of a corresponding mode), if the result of the identification is “No”, then the hotel mode not existing is prompted, and if the result of the identification is “Yes”, then the specific contents of the hotel mode parameter configuration file are written into the mode parameter storing module 102-1; and an identification of the end of the mode parameter configuration file (the end identification code of the parameter configuration file of a corresponding mode), if the result of the identification is “No”, the specific contents of the mode parameter configuration file, such as code identification or code parameter, are written continuously, and if the result of the identification is “Yes”, then it means that the specific contents of the mode parameter configuration file, such as code identification or code parameter, have been written completely. During writing, the specific contents of the hotel mode parameter configuration file may be verified simultaneously, so as to ensure the accuracy of the written specific contents of the hotel mode parameter configuration file, if error is found, the specific contents of the hotel mode parameter configuration file are rewritten, and if no error is found, subsequent specific contents of the hotel mode parameter configuration file are continued to be read and written.

The parameter setting state of the hotel mode of the second display device 102 is quit, and the mobile storage device 103 is removed from the mobile storage device hardware interface 102-2 of the second display device 102.

Next, the second display device 102 may display based on the display mode parameters of the first display device 101. So far, the hotel mode of a second display device 102 has been set. According to the above setting method, a plurality of the second display devices 102 to be set to the hotel mode in the same situation or the like may be set through the mobile storage device 103.

It should be understood herein that, in the first display device 101 and the second display device 102, selection of the “storage” function or the “loading configuration” function from the “storage/loading configuration” function is decided depending on whether the mode parameter configuration file named “HotelSetting.cfg” exists in the root directory of the mobile storage device 103 connected to the hardware interface thereof. If no mode parameter configuration file named “HotelSetting.cfg” exists in the root directory of the mobile storage device 103, then the “storage” function, such as the operation in the first display device 101 whose mode has been set, is performed; and if the mode parameter configuration file named “HotelSetting.cfg” exists in the root directory of the mobile storage device 103, then the “loading configuration” function, such as the operation in the second display device 102 whose mode is to be set, is performed.

It should be understood that, the setting method for the hotel mode of the display devices may also be applied to other display modes, such as a cruise ship mode, a hospital mode, and a prison mode, of the display devices, and the setting method and setting procedures are the same as above, which will not be repeated herein.

### Embodiment 4

The present embodiment provides a setting method of a display mode, and based on the hotel mode of the first display device 101 and the display device 102 having been set in the embodiment 3, in the present embodiment, the first display device 101 and the display device 102 are further set to a common user logo through the mobile storage device 103.

The setting method for setting a common user logo for display devices is basically the same as the setting method in the embodiment 2, extra added steps are as follows: when the mode parameters of the first display device 101 is set, a “Logo display” mode state should be set to “ON”; in addition to the configuration file (which is obtained from the first display device 101) for mode parameter configuration, the mobile storage device 103 further stores user logos (which are obtained from a camera, a computer or a device capable of storing pictures); in addition, when the mobile storage device 103 writes the mode parameter configuration file into the second display device 102, a user logo is also written into the second display device 102.

Hereinafter, specific setting process of a user logo is as follows:

A favorite picture is copied to the root directory of the formatted mobile storage device 103, wherein a file name of the picture is set to TV_Logo.jpg (the file name of the picture is required to be consistent with that of a user logo which can be identified by the mode parameter reading module), and the favorite picture may be copied from a computer, a camera or other mobile storage device 103.

The mobile storage device 103 storing the favorite picture is connected to the hardware interface 101-2, which is adapted to the mobile storage device 103, of the first display device 101 (that is, any one of display devices having been set to the hotel mode).

First, the display mode parameters of the first display device 101 are set as described in the embodiment 2, then the “user logo” configured in the hotel mode of the first display device 101 is manually set, an “update user logo (Update user Logo)” function item in the hotel mode is selected, the mode parameter reading module 101-3 of the first display device 101 starts to automatically research the root directory of the mobile storage device 103 for the picture whose picture file name is TV_Logo.jpg, if no corresponding picture file is found, the user logo not existing is prompted, and if a corresponding picture file is found, then the picture file is read and written into the inner mode parameter storing module 101-1. The parameter setting state of the hotel mode of the first display device 101 is quit, and the mobile storage device 103 is removed from the hardware interface 101-2 of the first display device 101.

In the above process, the mode parameter configuration file may be stored in the mobile storage device 103 only when the mode parameter setting for the first display device 101 has been completed but the user logo updating is not performed in the first display device 101, that is, the first display device 101 may just provide the mode parameter configuration file, and whether the user logo updating has been performed in the first display device 101 may be defined. That is to say, it just is needed to ensure that, before the mobile storage device 103 is connected to the second display device 102, the mobile storage device 103 has both the mode parameter configuration file and the picture file for power on displaying therein. Certainly, a conventional method is as follows: like the above process, all the mode parameters including the user logo updating are set for the first display device 101 first, then the mode parameter configuration file is stored in the mobile storage device 103, and the mode parameters are set for the display device 102.

Next, the mobile storage device 103 is connected to the hardware interface 102-2, which is adapted to the mobile storage device 103, of the second display device 102 (that is, any one of display devices for which the user logo is to be set).

The mode parameters of the second display device 102 are set as described in the embodiment 2 first, and an “update user logo (Update power on display picture)” function item is selected, then the user logo of the hotel mode of the second display device 102 is set to the picture file stored in the mobile storage device 103 using the picture file stored in the mobile storage device 103.

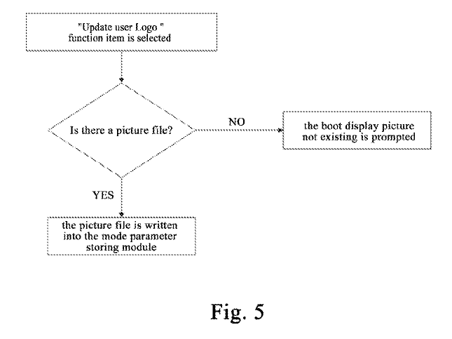

Specifically, as shown in FIG. 5, the “update user logo (Update user Logo)” function item in the hotel mode of the second display device 102 is selected, the mode parameter reading module 102-3 of the second display device 102 starts to automatically research the root directory of the mobile storage device 103 for the picture whose picture file name is TV_Logo.jpg, if no corresponding picture is found, the user logo not existing is prompted, and if a corresponding picture is found, then the picture file is read and written into the inner mode parameter storing module 102-1.

For the picture identification of the picture whose picture file name is TV_Logo.jpg, the mode parameter reading module 102-3 of the second display device 102 verifies the accuracy of the verification part of the mode parameter configuration file. If error occurs in the verification of the picture file, then the subsequent “update user logo (Update user Logo)” function cannot be activated accordingly, that is, the subsequent “update user logo” function cannot be selected.

Finally, the parameter setting state of the hotel mode of the second display device 102 is quit, and the mobile storage device 103 is removed from the hardware interface 102-2 of the second display device 102.

Next, the second display device 102 may display based on the user logo of the first display device 101.

So far, settings of the mode parameters of the hotel mode and the user logo of the first display device 101 and a second display device 102 are completed. According to the above setting method, a plurality of second display device 102 for which the user logo is to be set in the same or similar situation may be set through the mobile storage device 103.

It should be noted that, the setting method for the user logo of the display devices may also be applied to set the user logo for the display devices in a cruise ship mode, a hospital mode, and a prison mode, and the setting method and setting procedures are the same as above, which will not be repeated herein.

Advantageous effects of the present invention are as follows: in the embodiments 1-4, when the display mode is set, the second display device 102 may be set by extracting the display mode parameters of the first display device 101, and therefore, compared to manual setting, the operation is convenient and mistake is not easy to occur, thus on the premise of ensuring setting accuracy, the setting efficiency is increased.

It should be understood that, the above embodiments are only exemplary embodiments used to explain the principle of the present invention and the protection scope of the present invention is not limited thereto. The person skilled in the art can make various variations and modifications without departing from the spirit and scope of the present invention, and these variations and modifications should be considered to belong to the protection scope of the invention.

1-9. (canceled)

10. A setting method of a display mode, comprising the steps of:
setting display mode parameters of a first display device;
extracting and storing the display mode parameters of the first display device;
setting a second display device based on the display mode parameters of the first display device; and
making the second display device display based on the display mode parameters of the first display device.

11. The setting method of claim 10, wherein the first display device includes a mode parameter storing module, and the step of setting display mode parameters of a first display device comprises:
manually setting the display mode parameters of the first display device respectively to form a mode parameter configuration file, and storing the mode parameter configuration file in the mode parameter storing module of the first display device.

12. The setting method of claim 10, wherein the display mode parameters of the first display device include:
a brightness parameter, a contrast parameter, a sound parameter, a saturation parameter and a user logo parameter.

13. The setting method of claim 11, wherein the display mode parameters of the first display device include:
a brightness parameter, a contrast parameter, a sound parameter, a saturation parameter and a user logo parameter.

14. The setting method of claim 10, wherein the first display device includes a mobile storage device hardware interface, and the step of extracting and storing the display mode parameters of the first display device comprises:
connecting the mobile storage device to the mobile storage device hardware interface of the first display device;
storing the mode parameter configuration file in the first display device into the mobile storage device; and
removing the mobile storage device from the mobile storage device hardware interface of the first display device.

15. The setting method of claim 11, wherein the first display device includes a mobile storage device hardware interface, and the step of extracting and storing the display mode parameters of the first display device comprises:
connecting the mobile storage device to the mobile storage device hardware interface of the first display device;
storing the mode parameter configuration file in the first display device into the mobile storage device; and
removing the mobile storage device from the mobile storage device hardware interface of the first display device.

16. The setting method of claim 12, wherein the first display device includes a mobile storage device hardware interface, and the step of extracting and storing the display mode parameters of the first display device comprises:
connecting the mobile storage device to the mobile storage device hardware interface of the first display device;
storing the mode parameter configuration file in the first display device into the mobile storage device; and
removing the mobile storage device from the mobile storage device hardware interface of the first display device.

17. The setting method of claim 10, wherein the second display device includes a mobile storage device hardware interface and a mode parameter storing module, and the step of setting the second display device based on the extracted display mode parameters of the first display device comprises:
connecting the mobile storage device to the mobile storage device hardware interface of the second display device;
copying the mode parameter configuration file in the mobile storage device to the mode parameter storing module of the second display device; and
removing the mobile storage device from the mobile storage device hardware interface of the second display device.

18. The setting method of claim 11, wherein the second display device includes a mobile storage device hardware interface and a mode parameter storing module, and the step of setting the second display device based on the extracted display mode parameters of the first display device comprises:
connecting the mobile storage device to the mobile storage device hardware interface of the second display device;
copying the mode parameter configuration file in the mobile storage device to the mode parameter storing module of the second display device; and
removing the mobile storage device from the mobile storage device hardware interface of the second display device.

19. The setting method of claim 12, wherein the second display device includes a mobile storage device hardware interface and a mode parameter storing module, and the step of setting the second display device based on the extracted display mode parameters of the first display device comprises:
connecting the mobile storage device to the mobile storage device hardware interface of the second display device;
copying the mode parameter configuration file in the mobile storage device to the mode parameter storing module of the second display device; and
removing the mobile storage device from the mobile storage device hardware interface of the second display device.

20. The setting method of claim 14, wherein the second display device includes a mobile storage device hardware interface and a mode parameter storing module, and the step of setting the second display device based on the extracted display mode parameters of the first display device comprises:
connecting the mobile storage device to the mobile storage device hardware interface of the second display device;
copying the mode parameter configuration file in the mobile storage device to the mode parameter storing module of the second display device; and
removing the mobile storage device from the mobile storage device hardware interface of the second display device.

21. The setting method of claim 10, wherein the second display device includes a mode parameter reading module and a mode parameter running module, and the step of making the second display device display based on the display mode parameters of the first display device comprises:
the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

22. The setting method of claim 11, wherein the second display device includes a mode parameter reading module and a mode parameter running module, and the step of making the second display device display based on the display mode parameters of the first display device comprises:
the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

23. The setting method of claim 12, wherein the second display device includes a mode parameter reading module and a mode parameter running module, and the step of making the second display device display based on the display mode parameters of the first display device comprises:
the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

24. The setting method of claim 14, wherein the second display device includes a mode parameter reading module and a mode parameter running module, and the step of making the second display device display based on the display mode parameters of the first display device comprises:
the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

25. The setting method of claim 17, wherein the second display device includes a mode parameter reading module and a mode parameter running module, and the step of making the second display device display based on the display mode parameters of the first display device comprises:
the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

26. The setting method of claim 18, wherein the second display device includes a mode parameter reading module and a mode parameter running module, and the step of making the second display device display based on the display mode parameters of the first display device comprises:
the mode parameter reading module of the second display device reads the mode parameter configuration file from the mode parameter storing module of the second display device to the mode parameter running module, and the mode parameter running module runs the mode parameter configuration file, so that the second display device displays based on the display mode parameters of the first display device.

27. A display mode configuring system, comprising:
a first display device for generating a mode parameter configuration file based on a plurality of display mode parameters of the first display device;
a mobile storage device for storing the mode parameter configuration file therein when it is connected to the first display device; and
a second display device for reading the mode parameter configuration file from the mobile storage device and running it when the mobile storage device is connected thereto, so that the second display device displays based on the display mode parameters of the first display device.

28. The display mode configuring system of claim 27, wherein the first display device includes a first mode parameter storing module and a first mobile storage device hardware interface, the second display device includes a second mode parameter storing module and a second mobile storage device hardware interface, wherein the first mode parameter storing module stores the generated mode parameter configuration file, and the second mode parameter storing module stores the mode parameter configuration file read from the mobile storage device, and wherein the first mobile storage device hardware interface and the second mobile storage device hardware interface are used to connect with the mobile storage device.

29. The display mode configuring system of claim 28, wherein the first display device further includes a first mode parameter reading module and a first mode parameter running module, and the second display device further includes a second mode parameter reading module and a second mode parameter running module, wherein the first mode parameter reading module reads the mode parameter configuration file from the first mode parameter storing module to the first mode parameter running module, and the first mode parameter running module runs the mode parameter configuration file so that the first display device displays based on the display mode parameters, and the second mode parameter reading module reads the mode parameter configuration file from the second mode parameter storing module to the second mode parameter running module, and the second mode parameter running module runs the mode parameter configuration file so that the second display device displays based on the display mode parameters of the first display device.
